(19) United States
(12) Patent Application Publication
(10) Pub. No.: US 2023/0364866 A1
(43) Pub. Date: Nov. 16, 2023

(54) THREE-DIMENSIONAL STRUCTURED MULTI-LEVEL INTERLOCKING STRUCTURE AND PREPARATION METHOD THEREOF

(71) Applicants: The Boeing Company, Arlington, VA (US); Ningbo Institute of Materials Technology and Engineering, Chinese Academy of Sciences, Zhenhai District, Ningbo (CN)

(72) Inventors: Jianjun Guo, Ningbo (CN); Yifan Zhang, Ningbo (CN); Zhixiang Li, Ningbo (CN); Gaojie Xu, Ningbo (CN)

(73) Assignees: The Boeing Company, Arlington, VA (US); Ningbo Institute of Materials Technology and Engineering, Chinese Academy of Sciences, Zhenhai District, Ningbo (CN)

(21) Appl. No.: 18/247,917

(22) PCT Filed: Jan. 12, 2022
(86) PCT No.: PCT/US2022/012096

§ 371 Date: Apr. 5, 2023

(30) Foreign Application Priority Data
Feb. 7, 2021 (CN) 202110177760.X

(51) Int. Cl. B29C 65/00

(52) U.S. Cl. CPC B29C 66/71; B29C 66/028; B29C 66/3032; B29C 2043/025

(57) ABSTRACT

A three-dimensional structured multi-level interlocking structure and a preparation method thereof, the multi-level interlocking structure comprises: a first interlocking structure comprising a first bonding component, first bonding troughs and first macrostmctures alternately positioned on the surface of the first bonding component, and a second interlocking structure comprising a second bonding component, second bonding troughs and second macrostmctures alternately positioned on the surface of the second bonding component, the first macrostructures are aligned with the second bonding trough, and the second macrostmctures are aligned with the first bonding trough; and the first macrostructure has a first end away from the first bonding component and the second macrostructure has a first end away from the second bonding component, the first ends of the first macrostructure and the second macrostructure comprise a top plane, the first end of the first macrostructure extends past the top plane of the second macrostructure, or the first end of the second macrostructure extends past the top plane of the first macrostructure. With the structure applied, the bonding effect is improved and the bonding strength is reinforced, so that the mechanical strength of interlock between the structures is reinforced.

### PRIORITY

This application claims priority from Chinese Pat. App. No. 202110177760X filed on Feb. 7, 2021.

### FIELD

The present disclosure relates to bonding structures and methods of forming the same. Particularly, the disclosure relates to a three-dimensional structured multi-level interlocking structure having reinforced bonding strength and a method for forming same.

### BACKGROUND

It is advantageous to reduce material cost and weight without the use of fasteners by connecting metal and composite mechanical structures by means of adhesives within a framework of lightweight structures. One of the major problems of bonding with adhesives is how to optimize the bonding strength. In many mechanisms that explain the adhesion phenomenon, the roughness of the adhesive interface is considered to be a major factor in improving the energy dissipation process in polymer adhesives by means of micro-scale mechanical interlocking mechanisms. Conventional surface polishing techniques provide higher surface processing efficiency, but variability in surface polishing processing techniques results in unpredictable bonding strengths, which can lead to problems that do not meet certification requirements. In order to obtain a controlled mechanical interlocking mechanism, surface interlocking structures formed on the surface of the adherend are very effective in improving the failure load and damage tolerance of the adhesive joint.

Boiling water etching, epitaxial growth and other techniques have been developed to obtain structured metal bonding surfaces. However, for techniques such as boiling water etching, which are highly sensitive to alloy composition, thereby the controllability of the surface geometry is poor. In the bonding process of mechanical structures such as airplanes and the like, the mechanical interlock based on random arrangement cannot realize quantitative evaluation of the influence on the bonding strength, and cannot reasonably design the optimal bonding strength. A more advanced method is to adopt the laser surface processing technology to obtain the uniformly provided surface microstructure so as to greatly increase the bonding performance of the surface.

It is noteworthy, however, that machining or even laser cutting of polymer composites is a complex process because fibers and polymer matrices have quite different physical and thermal properties and react differently to high-energy lasers. Another major problem with laser processing composite materials is the production of toxic by-products that adversely affect material properties and can pose health risks to maintenance technicians.

The micro-structured bonding surface can effectively improve the bonding effect by generating a micro-scale mechanical interlocking mechanism. However, increasing the surface roughness will reduce adhesive diffusion, particularly for high viscosity adhesives, and may cause stress concentrations and lead to premature failure. At the same time, the diffusion mechanism will only work if the adhesive is capable of effectively diffusing on the structured surface and requires an effective structural part. That is, the macrostructure, mesostructure and patterned microstructure of the surface each play a different role. Therefore, there is a need for surface multi-level interlocking structures with patterned microstructure mechanisms of different scales to quantitatively evaluate and effectively improve bonding performance.

### SUMMARY

The main objects of the disclosure provide a three-dimensional structured multilevel interlocking structure and a preparation method thereof, so as to solve the problems in the prior art.

In order to achieve the above object, according to one aspect of the disclosure, there is provided a three-dimensional structured multi-level interlocking structure, comprising a first interlocking structure and a second interlocking structure, wherein the first interlocking structure comprises a first bonding component, at least one first bonding trough and at least one first macrostructure alternately positioned on the surface of the first bonding component, and the second interlocking structure comprises a second bonding component, at least one second bonding trough and at least one second macrostructure alternately positioned on the surface of the second bonding component, wherein the at least one first macrostructure is aligned with the at least one second bonding trough, and the at least one second macrostructure is aligned with the at least one first bonding trough; and wherein the at least one first macrostructure has a first end away from the first bonding component and the at least one second macrostructure has a first end away from the second bonding component, the first ends of the at least one first macrostructure and the at least one second macrostructure comprise a top plane, wherein the first end of the at least one first macrostructure extends past the top plane of the first end of the at least one second macrostructure, or wherein the first end of the at least one second macrostructure extends past the top plane of the first end of the at least one first macrostructure.

Further, in the three-dimensional structured multi-level interlocking structure described above, at least one first patterned microstructure is further included on the top plane of the at least one first macrostructure, and/or at least one second patterned microstructure is further included on the top plane of the at least one second macrostructure.

Further, in the three-dimensional structured multi-level interlocking structure described above, the at least one first macrostructure extends completely through the at least one second patterned microstructure and the first end of the at least one first macrostructure extends past the top plane of the first end of the at least one second macrostructure, or the at least one second macrostructure extends completely through the at least one first patterned microstructure and the first end of the at least one second macrostructure extends past the top plane of the first end of the at least one first macrostructure.

Further, in the three-dimensional structured multi-level interlocking structure described above, a fibrous reinforcing material is provided between the first bonding component and the at least one first macrostructure and between the second bonding component and the at least one second macrostructure, and the fibrous reinforcing material extends through, preferably vertically through, an interface between the first bonding component and the at least one first macrostructure and an interface between the second bonding component and the at least one second macrostructure.

Further, in the three-dimensional structured multi-level interlocking structure described above, the first interlocking structure comprises two or more first macrostructures and two or more first patterned microstructures positioned on the top planes of the first macrostructures, and the second interlocking structure comprises two or more second macrostructures and two or more second patterned microstructures positioned on the top planes of the second macrostructures.

Further, in the three-dimensional structured multi-level interlocking structure described above, a length of the at least one second bonding trough is greater than a length of the at least one first macrostructure in a direction parallel to the distribution of the at least one first macrostructure, and/or a length of the at least one first bonding trough is greater than a length of the at least one second macrostructure; preferably, the length of the at least one second bonding trough equals to a sum of the length of the at least one first macrostructure plus a gap length or twice the gap length between the first macrostructures and the second macrostructures parallel to the direction of distribution of the at least one first macrostructure; the gap length is equal to the adhesive thickness in the direction parallel to the distribution of the at least one first macrostructure, and the gap length is greater than or equal to the adhesive thickness in the direction perpendicular to the bonding surface; and/or the length of the at least one first bonding trough equals to a sum of the length of the at least one second macrostructure plus the gap length or twice the gap length between the first macrostructures and the second macrostructures in a direction parallel to the distribution of the at least one second macrostructure; the gap length is equal to the adhesive thickness in the direction parallel to the distribution of the at least one second macrostructure, and the gap length is greater than or equal to the adhesive thickness in the direction perpendicular to the bonding surface.

Further, in the three-dimensional structured multi-level interlocking structure described above, heights of the at least one first macrostructure and of the at least one second macrostructure are between 0.02 mm and 0.2 mm, and heights of the at least one first patterned microstructure and of the at least one second patterned microstructure are between 0.001 mm and 0.015 mm.

Further, in the three-dimensional structured multi-level interlocking structure described above , the heights of at least one of the at least one first macrostructure and of the at least one second macrostructure are half or more of the adhesive thickness in the direction perpendicular to the bonding surface.

Further, in the three-dimensional structured multi-level interlocking structure described above, the at least one first macrostructure and the at least one second macrostructure, the at least one first patterned microstructure and the at least one second patterned microstructure, and the first bonding component and the second bonding component are made of the same material or different materials selected from the group consisting of polymer resins and polymer resin-based composite materials.

According to another aspect of the disclosure, it provides a method for preparing the three-dimensional structured multi-level interlocking structure, comprising:
providing a first interlocking structure,
providing a second interlocking structure, and
bonding the first interlocking structure and the second interlocking structure by means of an adhesive such that at least one first macrostructure is aligned with the at least one second bonding trough and the at least one second macrostructure is aligned with the at least one first bonding trough, and wherein the at least one first macrostructure has a first end away from the first bonding component and the at least one second macrostructure has a first end away from the second bonding component, the first ends of the at least one first macrostructure and the at least one second macrostructure comprise a top plane, wherein the first end of the at least one first macrostructure extends past the top plane of the first end of the at least one second macrostructure, or wherein the first end of the at least one second macrostructure extends past the top plane of the first end of the at least one first macrostructure, and
wherein the at least one first macrostructure and the at least one second macrostructure are formed by a powder bed forming, fused deposition molding, nanoimprinting or laser engraving process and the like.

Further, according to the method described above, the at least one first patterned microstructure is further included on a top plane of the at least one first macrostructure, and/or the at least one second patterned microstructure is further included on a top plane of the at least one second macrostructure;

Further, according to the method described above, the at least one first macrostructure extends completely through the at least one second patterned microstructure and the first end of the at least one first macrostructure extends past the top plane of the first end of the at least one second macrostructure, or the at least one second macrostructure extends completely through the at least one first patterned microstructure and the first end of the at least one second macrostructure extends past the top plane of the first end of the at least one first macrostructure; and the at least one first patterned microstructure and the at least one second patterned microstructure are formed by powder bed forming, fused deposition molding, nano-imprinting, or laser engraving processes and the like.

Further, according to the method described above, wherein before the first interlocking structure and the second interlocking structure are bonded by an adhesive, the at least one second patterned microstructure on the top planes of the at least one second macrostructure and/or the at least one first patterned microstructure on the top planes of the at least one first macrostructure and the at least one first bonding trough and/or the at least one second bonding trough are subjected to a surface treatment, such as at a temperature of 0-150 degrees centigrade by plasma treatment or by mechanical abrasion or chemical etching, etc., so that roughness of the bonding surface is between 1.5 and 15 micrometers, and the contact angle with water is below 18 degrees.

Further, according to the method described above, the gas used in the plasma surface treatment process is selected from at least one of oxygen, air, argon and helium.

Further, according to the method described above, the first interlocking structure and the second interlocking structure are combined by an adhesive within 8 hours after surface treatment by plasma.

By applying the technical solution of the disclosure, a three-dimensional interlocking structure is formed on the bonding component surfaces by macrostructures and patterned microstructures thereon, wherein the interaction between the macrostructures can provide a mechanical interlock, thereby greatly improving the bonding effect and enhancing the bonding strength, and the interaction between the microstructures on the top planes of the macrostructures and the adhesive can provide an additional energy dissipation effect, thereby further improving the bonding effect and enhancing the bonding strength. The mechanical strength of the interlock therebetween is thereby reinforced.

### BRIEF DESCRIPTION OF THE DRAWINGS

The accompanying drawings, which constitute a part of this disclosure, are used to provide further understanding of the disclosure, illustrated embodiments of the disclosure together with the description, serve to interpret the disclosure and are not to be construed as unduly limiting the invention. In the drawings:

FIG. 1 shows a partial longitudinal cross-sectional perspective view of a first or second interlocking structure in accordance with one embodiment of the disclosure, wherein the hatched portion shows a longitudinal cross section.

FIG. 2A shows a longitudinal cross-sectional view of a first interlocking structure along a cross section of a fibrous reinforcing material in accordance with one embodiment of the disclosure, wherein the first interlocking structure has a first bonding component, first macrostructures, and a fibrous reinforcing material provided between the first macrostructures and the first bonding component on the cross section.

FIG. 2B shows a longitudinal cross-sectional view of a second interlocking structure along a cross section of a fibrous reinforcing material according to an embodiment of the disclosure, wherein the second interlocking structure comprises a second bonding component and second macrostructures, and a fibrous reinforcing material is provided between the second macrostructures and the second bonding component on the cross section.

FIG. 3A shows a longitudinal cross-sectional view of the first interlocking structure shown in FIG. 2A in which the first patterned microstructure is provided along a cross section of a fibrous reinforcing material.

FIG. 3B shows a longitudinal cross-sectional view of the second interlocking structure shown in FIG. 2B in which the second patterned microstructure is provided along a cross section of a fibrous reinforcing material.

FIG. 4 shows a longitudinal cross-sectional view along a cross section of a fibrous reinforcing material after alignment and bonding of the first interlocking structure shown in FIG. 3A with the second interlocking structure shown in FIG. 3B.

FIGS. 5A and 5B show partial perspective views of first and second interlocking structures prepared in accordance with Example 1 of the disclosure, respectively.

FIGS. 6A and 6B show a partial perspective view of a first or second interlocking structure prepared in accordance with Example 2 of the disclosure.

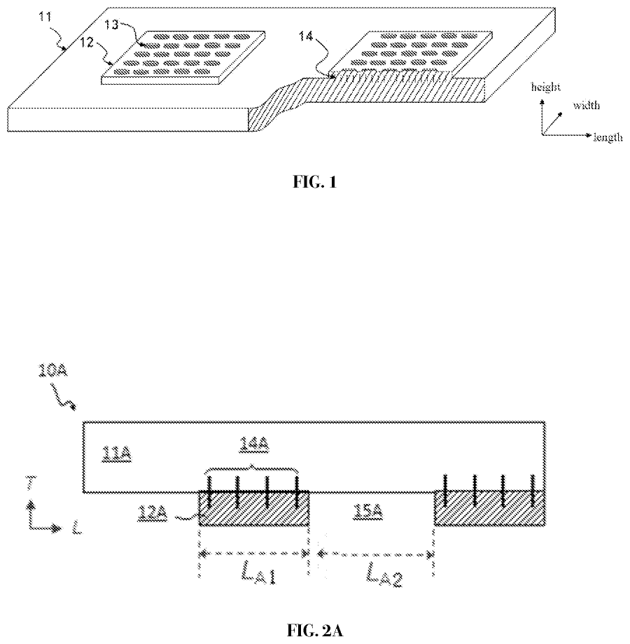

### DETAILED DESCRIPTION

It should be noted that the embodiments and features in the embodiments herein may be combined with one another without conflict. Hereinafter, the disclosure will be described in detail with reference to examples, and the following detailed description of the disclosure should not be construed as limiting the scope of the claims of the present disclosure.

For solving the defects of the prior art mentioned in the background art, one embodiment of the invention provides a three-dimensional structured multi-level interlocking structure, comprising a first interlocking structure and a second interlocking structure, wherein the first interlocking structure comprises a first bonding component, at least one first bonding trough and at least one first macrostructure alternately positioned on the surface of the first bonding component, and the second interlocking structure comprises a second bonding component, at least one second bonding trough and at least one second macrostructure alternately positioned on the surface of the second bonding component, wherein the at least one first macrostructure is aligned with the at least one second bonding trough, and the at least one second macrostructure is aligned with the at least one first bonding trough; and wherein the at least one first macrostructure has a first end away from the first bonding component and the at least one second macrostructure has a first end away from the second bonding component, the first ends of the at least one first macrostructure and the at least one second macrostructure comprise a top plane, wherein the first end of the at least one first macrostructure extends past the top plane of the first end of the at least one second macrostructure, or wherein the first end of the at least one second macrostructure extends past the top plane of the first end of the at least one first macrostructure.

In the three-dimensional structured multi-level interlocking structure according to the disclosure, the interaction between the first macrostructures and the second macrostructures can provide a mechanical interlock, so that the bonding effect and the bonding strength of the multi-level interlocking structure are greatly improved.

In a preferred embodiment of the three-dimensional structured multi-level interlocking structure according to the disclosure, at least one first patterned microstructure, preferably two or more first patterned microstructures, is further included on the top plane of the at least one first macrostructure, and/or at least one second patterned microstructure, preferably two or more second patterned microstructures, is further included on the top plane of the at least one second macrostructure; the at least one first macrostructure extends completely through the at least one second patterned microstructure (preferably extends through two or more second patterned microstructures) and the first end of the at least one first macrostructure extends past the top plane of the first end of the at least one second macrostructure, or the at least one second macrostructure extends completely through the at least one first patterned microstructure (preferably extends through two or more first patterned microstructures) and the first end of the at least one second macrostructure extends past the top plane of the first end of the at least one first macrostructure. The interaction between the first and second macrostructures can provide a mechanical interlock, while the interaction between the microstructures of the top planes of the first and second macrostructures and the adhesive can provide an additional energy dissipation effect, thereby further improving the bonding effect.

In another preferred embodiment of the three-dimensional structured multi-level interlocking structure according to the disclosure, a fibrous reinforcing material is provided between the first bonding component and the at least one first macrostructure and between the second bonding component and the at least one second macrostructure, and the fibrous reinforcing material extends through, preferably vertically through, an interface between the first bonding component and the at least one first macrostructure and an interface between the second bonding component and the at least one second macrostructure. The mechanical interlock between the first and second macrostructures typically causes external forces to be concentrated on the macrostructures itself, which may cause damage to the macrostructures, and the fibrous reinforcing material extending between the macrostructures and the bonding components can further provide additional reinforcing effect, thereby inhibiting such damage.

In yet another preferred embodiment of the three-dimensional structured multilevel interlocking structure according to the disclosure, the first interlocking structure comprises two or more first macrostructures and two or more first patterned microstructures (more preferably, three, four, five, or six or more first patterned microstructures) positioned on the top planes of the first macrostructures, and the second interlocking structure comprises two or more second macrostructures and two or more second patterned microstructures (more preferably, three, four, five, or six or more second patterned microstructures) positioned on the top planes of the second macrostructures. The above interlocking structure, with a plurality of first and second macrostructures and a plurality of first and second microstructures, can further improve the bonding effect and related bonding strength. A person skilled in the art would be able to appropriately set the numbers of macrostructures and microstructures in the interlocking structure according to requirements so as to achieve the required bonding effect and bonding strength.

In yet another preferred embodiment of the three-dimensional structured multilevel interlocking structure according to the disclosure, a length L_{B1} of the at least one second bonding trough is greater than a length L_{A1} of the at least one first macrostructure and/or a length L_{A2} of the at least one first bonding trough is greater than a length L_{B2} of the at least one second macrostructure in a direction parallel to the distribution of the at least one first macrostructure; preferably, the length L_{B1} of the at least one second bonding trough equals to a sum of the length L_{A1} of the at least one first macrostructure plus a gap length L_{C} or twice the gap length L_{C} between the first macrostructures and the second macrostructures in a direction L parallel to distribution of the at least one first macrostructure; the gap length L_{C} is equal to the adhesive thickness in a direction L parallel to the distribution of at least one first macrostructure and is greater than or equal to an adhesive thickness L_{T} in a direction T perpendicular to the bonding surface; and/or the length L_{A2} of the at least one first bonding trough equals to a sum of the length L_{B2} of the at least one second macrostructure plus the gap length L_{C} or twice the gap length L_{C} between the first macrostructures and the second macrostructures in a direction parallel to the distribution of the at least one second macrostructure; the gap length L_{C} is equal to the adhesive thickness in the direction L parallel to the distribution of the at least one second macrostructure and is greater than or equal to the adhesive thickness L_{T} in the direction L perpendicular to the bonding surface.

Preferably, the gap lengths between the first macrostructures and the second macrostructures in the direction L to the distribution of the second macrostructures are equal to the adhesive thickness which is typically 0.01-1.0 mm in the direction L parallel to the distribution of the at least one second macrostructure.

More preferably, the distance between corresponding portions of the first exemplary interlocking structure and the second interlocking structure is the adhesive thickness. Through the structure, the first macrostructures can be aligned and combined better with the second bonding troughs, and the bonding effect and the bonding strength are further improved.

In another preferred embodiment of the three-dimensional structured multi-level interlocking structure according to the disclosure, the height of the at least one first macrostructure and the height of the at least one second macrostructure are between 0.02 and 0.2 mm and the height of the at least one first patterned microstructure and the height of the at least one second patterned microstructure are between 0.001 and 0.015 mm.

These macrostructures generally have a higher mechanical strength than macrostructures having a height of less than 0.02 mm, thereby providing a stronger mechanical interlock against external forces. In addition, these patterned microstructures can generally provide greater chemical or physical interaction with the adhesive, provide additional surface roughness, and provide greater mechanical interlock between the adhesive and the patterned microstructures when subjected to external forces, thereby enhancing the mechanical strength of the interlock therebetween, as compared to patterned microstructures having a height greater than 0.015 mm.

In a further preferred embodiment of the three-dimensional structured multi-level interlocking structure according to the disclosure, at least one of the heights of the at least one first macrostructure and of the at least one second macrostructure is half or more of the adhesive thickness in the direction T perpendicular to the bonding surface. With such a height being set, it may be better to extend the first end of the at least one first macrostructure past the top plane of the first end of the at least one second macrostructure or the first end of the at least one second macrostructure past the top plane of the first end of the at least one first macrostructure, thereby providing a stronger mechanical interlock and enhancing the mechanical strength of the interlocking therebetween.

In another preferred embodiment of the three-dimensional structured multi-level interlocking structure according to the disclosure, the at least one first macrostructure and the at least one second macrostructure, the at least one first patterned microstructure (preferably two or more first patterned microstructures) and the at least one second patterned microstructure (preferably two or more second patterned microstructures), and the first bonding component and the second bonding component may be made of the same material or different materials.

The material may be selected from polymeric resins and polymeric resin based composite materials.

The polymer resin is especially selected from but not limited to nylon (e.g., PA12, PA6, or PA66), polyimide (PI) resins (e.g., polycondensation-type aromatic polyimide, polybismaleimide, or polyetherimide PEI, etc.), and polyaryletherketone (PAEK) resins (e.g., polyetheretherketone (PEEK), polyetherketone (PEK), polyetherketoneketone (PEKK), polyetheretherketoneketone (PEEKK), or polyetherketoetherketoneketone (PEKEKK), and the like), or multilayer combinations of the above resins.

The polymer resin-based composite materials are especially selected from but not limited to above polymer resin materials enhanced by high-performance fibers such as glass fibers, carbon fibers, carbon nanotubes, metal fibers, polyaramid fibers and basalt fibers, or powder materials such as graphene, nano silicon oxide, nano silicon carbide and the like. The material is not particularly limited, and a person skilled in the art would be able to select a desired material according to practical requirements.

In another typical embodiment of the disclosure, it provides a method for preparing the three-dimensional structured multi-level interlocking structure described above, comprising:
providing a first interlocking structure,
providing a second interlocking structure, and
bonding the first interlocking structure and the second interlocking structure by means of an adhesive such that at least one first macrostructure is aligned with the at least one second bonding trough and the at least one second macrostructure is aligned with the at least one first bonding trough, and wherein the at least one first macrostructure has a first end away from the first bonding component and the at least one second macrostructure has a first end away from the second bonding component, the first ends of the at least one first macrostructure and the at least one second macrostructure comprise a top plane, wherein the first end of the at least one first macrostructure extends past the top plane of the first end of the at least one second macrostructure, or wherein the first end of the at least one second macrostructure extends past the top plane of the first end of the at least one first macrostructure, and
wherein the at least one first macrostructure and the at least one second macrostructure are formed by a powder bed forming, fused deposition molding, nanoimprinting or laser engraving process, and the like.

In a preferred embodiment of the method according to the disclosure, the at least one first patterned microstructure (preferably having two or more first patterned microstructures, more preferably having three, four, five, or six or more first patterned microstructures) is further included on the top planes of the at least one first macrostructure, and/or the at least one second patterned microstructure (preferably having two or more second patterned microstructures, more preferably having three, four, five, or six or more second patterned microstructures) is further included on the top planes of the at least one second macrostructure;

In another preferred embodiment of the method according to the disclosure, the at least one first macrostructure extends completely through the at least one second patterned microstructure (preferably through two or more second patterned microstructures, more preferably through three, four, five, or six or more second patterned microstructures) and the first end of the at least one first macrostructure extends past the top plane of the first end of the at least one second macrostructure, or the at least one second macrostructure extends completely through the at least one first patterned microstructure (preferably through two or more first patterned microstructures, more preferably through three, four, five, or six or more first patterned microstructures) and the first end of the at least one second macrostructure extends past the top plane of the first end of the at least one first macrostructure; and the at least one first patterned microstructure and the at least one second patterned microstructure are formed by powder bed forming, fused deposition molding, nano-imprinting, or laser engraving processes, and the like.

To obtain the best bonding effect, ensure the precision of the microstructures of the bonded surfaces, and prevent decomposition of the high polymer/polymer, in the method according to the disclosure, before the first interlocking structure and the second interlocking structure are bonded by an adhesive, the at least one second patterned microstructure (preferably two or more second patterned microstructures, more preferably three, four, five, or six or more second patterned microstructures) on the top plane of the at least one second macrostructure and/or the at least one first patterned microstructure (preferably two or more first patterned microstructures, more preferably three, four, five, or six or more first patterned microstructures) on the top plane of the at least one first macrostructure and the at least one first bonding trough and/or the at least one second bonding trough are subjected to a surface treatment, such as at a temperature of 0-150 degrees centigrade by plasma treatment or by mechanical abrasion or chemical etching, so that roughness of the bonding surface is between 1.5 and 15 micrometers, and the contact angle with water is below 18 degrees.

In the method according to the disclosure, the gas used in the plasma surface treatment process is selected from at least one of oxygen, air, argon and helium.

In the method according to the disclosure, the first interlocking structure and the second interlocking structure are combined/bonded by an adhesive within 8 hours after surface treatment by plasma.

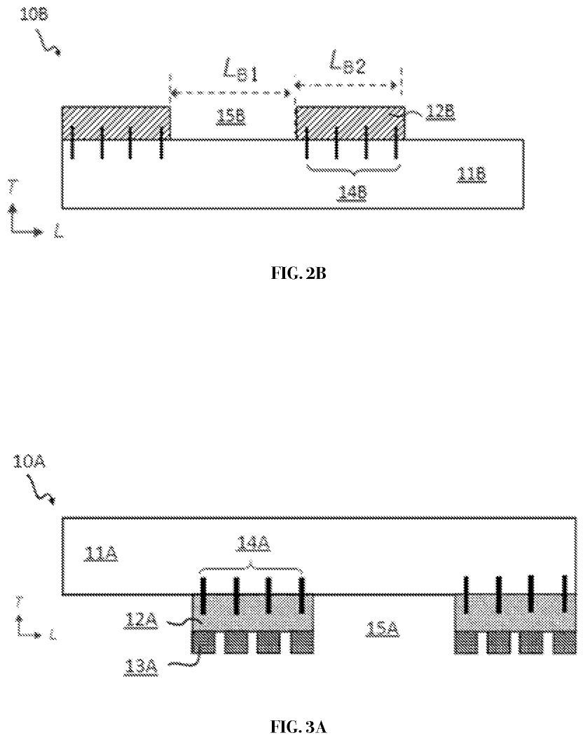

In order to better understand the three-dimensional structured multi-level interlocking structure of the disclosure, a first interlocking structure 10A and a second interlocking structure 10B, which may be used in the disclosure, are shown in FIGS. 2A and 2B, respectively, as described below with reference to the accompanying drawings.

In subsequent processing steps of the disclosure, the first interlocking structure 10A and the second interlocking structure 10B will be formed or processed in any order.

In some embodiments, the first interlocking structure 10A and the second interlocking structure 10B may be formed or processed simultaneously or separately.

The first interlocking structure 10A shown in FIG. 2A comprises a first bonding component 11A, first macrostructures 12A, and a fibrous reinforcing material 14A between the first macrostructures 12A and the first bonding component 11A embedded in the longitudinal cross section. It should be understood that the fibrous reinforcing material 14A present on this longitudinal cross section is shown by way of example only, and that the fibrous reinforcing material 14A between the first macrostructures 12A and the first bonding component 11A embedded in the first macrostructures 12A may be not only on this longitudinal cross section, but also on a plurality of longitudinal cross sections as required. As a specific example, there may also be no fibrous reinforcing material 14A between the first macrostructures 12A and the first bonding component 11A.

Similarly, the second interlocking structure 10B shown in FIG. 2B comprises a second bonding component 11B, second macrostructures 12B, and a fibrous reinforcing material 14B between the second macrostructures 12B and the second bonding component 11B embedded in the longitudinal cross section. It should be understood that the fibrous reinforcing material 14B present on this longitudinal cross section is shown by way of example only, and that the fibrous reinforcing material 14B between the second macrostructures 12B and the second bonding component 11B embedded in the second macrostructures 12B is present not only on this longitudinal cross section, but also on a plurality of longitudinal cross sections as required. As a specific example, there may also be no fibrous reinforcing material 14B between the second macrostructures 12B and the second bonding component 11B.

In some embodiments, the materials used for the first bonding component 11A and the second bonding component 11B may include a polymer resin. Polymer resin materials that may be used for the first bonding component 11A and the second bonding component 11B may include, but are not limited to, nylon (e.g., PA12, PA6, or PA66), polyimide (PI) resins (e.g., polycondensation-type aromatic polyimide, polybismaleimide, polyetherimide PEI, etc.), and polyaryletherketone (PAEK) resins (e.g., polyetheretherketone (PEEK), polyetherketone (PEK), polyetherketoneketone (PEKK), polyetheretherketoneketone (PEEKK), polyetherketoetherketoneketone (PEKEKK), and the like) resins or multilayer combinations thereof. In some embodiments, the resin material used for producing the first bonding component 11A may be the same as the resin material used for producing the second bonding component 11B. In other embodiments, the resin material used for producing the first bonding component 11A may be different from the resin material used for producing the second bonding component 11B.

In further embodiments, the first bonding component 11A and the second bonding component 11B may be polymer resin-based composite materials. In the disclosure, “polymer resin-based composite materials” mean that the entire bonding component is composed of a polymer resin and a reinforcing material. Typical reinforcing materials include high performance fibers such as carbon fibers, carbon nanotubes, metal fibers, polyaramid fibers and basalt fibers; and the reinforcing material can also be a powder material such as graphene, nano silicon oxide, nano silicon carbide and the like, or glass fiber. Preferably, the disclosure employs a high performance fibrous material having a modulus of elasticity greater than that of the polymer resin. In some embodiments, the reinforcing material may be comprised of one of the reinforcing materials described above. In other embodiments, the reinforcing material may be comprised of a mixture of two or more of the afore-mentioned reinforcing materials or a multilayer stack thereof.

As described above, the first interlocking structure 10A includes first macrostructures 12A connected to the first bonding component 11A and the second interlocking structure 10B includes second macrostructures 12B connected to the second bonding component 11B. Some examples of suitable materials that may be used for the first macrostructures 12A and the second macrostructures 12B include, but are not limited to, polymer resins or polymer resin-based composite materials.

Polymeric resin materials, which may include, but are not limited to, nylon (e.g., PA12, PA6, or PA66), polyimide (PI) resins (e.g., condensation-polymerized aromatic polyimides, polybismaleimides, polyetherimides (PEI), etc.), and polyaryletherketone (PAEK) resins (e.g., polyetheretherketone (PEEK), polyetherketone (PEK), polyetherketoneketone (PEKK), polyetheretherketoneketone (PEEKK), polyetherketoetherketoneketone (PEKEKK), and the like), or multilayer combinations of the above resins.

The polymer resin-based composite materials comprise above polymer resin materials enhanced by high-performance fibers such as glass fibers, carbon fibers, carbon nanotubes, metal fibers, polyaramid fibers, basalt fibers and the like, or powder materials such as graphene, nano silicon oxide, nano silicon carbide and the like. In some embodiments, the material used for producing the first macrostructures 12A and the second macrostructures 12B may be the same as the material used for producing the first bonding component 11A and the second bonding component 11B. In other embodiments, the material used for producing the first macrostructures 12A and the second macrostructures 12B may be different than the material used for producing the first bonding component 11A and the second bonding component 11B.

Preferably, in embodiments of the disclosure, a high performance fibrous material having a modulus of elasticity greater than that of the polymer resin is used. In some embodiments, the reinforcing material may be comprised of one of the reinforcing materials described above. In other embodiments, the reinforcing material may be comprised of a mixture of two or more of the afore-mentioned reinforcing materials or a multilayer stack thereof.

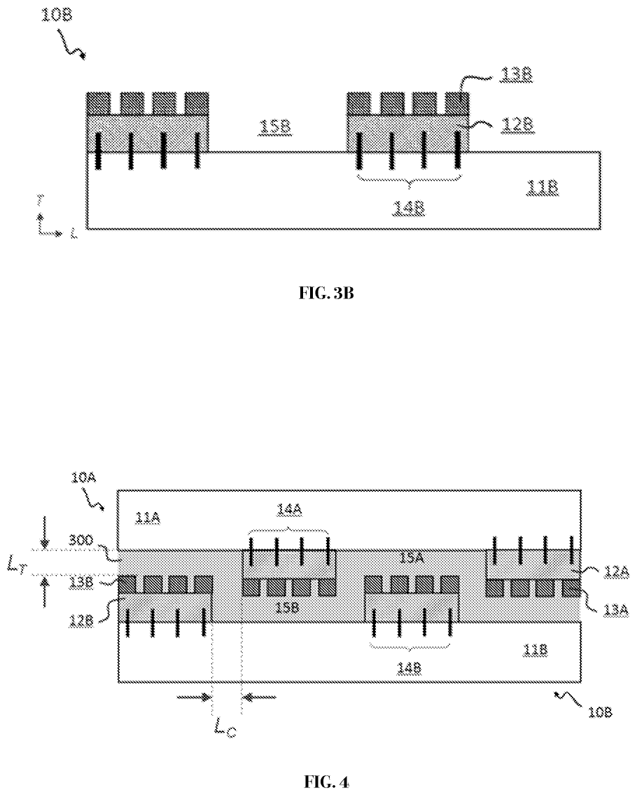

Referring to FIGS. 2A, 2B, 3A and 3B, the first macrostructures 12A and the second macrostructures 12B generally have a height greater than 0.02 mm in a direction T perpendicular to the bonding surface.

The stronger mechanical interlock against external forces is provided between the first macrostructures 12A and the second macrostructures 12B than macrostructures having a height less than 0.02 mm.

In one example, for the heights of the first macrostructures 12A and the second macrostructures 12B in the direction T perpendicular to the bonding surface, other heights may be used that are less than or greater than the above range of heights, but such that at least one of the heights of the first macrostructures 12A and the second macrostructures 12B needs to be greater than half of the adhesive thickness, in order that the first end of the at least one first macrostructure 12A extends completely through the second bonding component surface and past the top plane of the first end of the at least one second macrostructure 12Bafter completing the bonding; alternatively, the first end of the at least one second macrostructure 12B extends completely through the first structured bonding component surface and past the top plane of the first end of the at least one first macrostructure 12A.

The at least one of the first macrostructures 12A and the second macrostructures 12B may be formed simultaneously or separately with the first bonding component 11A or the second bonding component 11B using techniques well known in the mechanical processing industry, such as nano-imprint and laser engraving processes; 3D printing processes such as powder bed forming, fused deposition molding and the like can also be used for simultaneous or separate molding.

As described above, with reference to FIGS. 2A, 2B, 3A, 3B and 4, the first interlocking structure 10A and the second interlocking structure 10B further include a first fibrous reinforcing material 14A embedded between the first macrostructures 12A and the first bonding component 11A, and a second fibrous reinforcing material 14B embedded between the second macrostructures 12B and the second bonding component 11B, respectively. The first fibrous reinforcing material 14A and the second fibrous reinforcing material 14B include high-performance fibers such as carbon fibers, carbon nanotubes, metal fibers, aramid fibers, basalt fibers, and the like.

It should be understood that the fibrous reinforcing materials 14A and 14B in this longitudinal cross section are shown by way of example only, and that the first fibrous reinforcing material 14A between the first macrostructures 12A and the first bonding component 11A and the fibrous reinforcing material 14B between the second macrostructures 12B and the second bonding component 11B embedded in the second macrostructures 12B are not only in this longitudinal cross section, but may also be in a plurality of longitudinal cross sections as required. As a specific example, there may also be no fibrous reinforcing material 14A and/or 14B between the first macrostructures 12A and the first bonding component 11A and/or between the second macrostructures 12B and the second bonding component 11B.

In one embodiment, the reinforcing material may be comprised of one of the reinforcing materials described above. In other embodiments, the reinforcing material may be comprised of a mixture of several of the afore-mentioned reinforcing materials or a multilayer stack thereof. In the disclosure, a high-performance fiber material having a modulus of elasticity greater than that of the polymer resin is used, and it is possible to effectively prevent the first macrostructures 12A and the second macrostructures 12B from being detached from the surfaces of the first bonding component 11A and the second bonding component 11B due to concentration of stress on the macrostructures.

In a typical embodiment, fiber tear failure often occurs due to the weak interaction between the fibrous reinforcing materials 14A, 14B and the constituent materials of the macrostructures 12A, 12B; in other embodiments, the fibrous reinforcing materials 14A, 14B are not effectively embedded between the macrostructures 12A, 12B and the adhesive elements 11A, 11B, which also cause the first macrostructures 12A and the second macrostructures 12B to peel off, thereby failing to further enhance the bonding effect.

At least one of the first fibrous reinforcing material 14A and the second fibrous reinforcing material 14B may be formed by processing at the interfaces of the macrostructures 12A, 12B and the bonding components 11A, 11B using fiber composite reinforcing material processing techniques well known in the resin processing industry, such as extrusion and hot pressing processes; a 3D printing material addition process such as powder bed forming, fused deposition molding and ink jet printing may also be used to form the first fibrous reinforcing material 14A and the second fibrous reinforcing material 14B at the interfaces between the macrostructures 12A, 12B and the bonding components 11A, 11B.

In some embodiments, conventional plastic processing techniques are typically employed to form composite materials with randomly disposed fibrous reinforcing material. In other embodiments, a material addition technique such as 3D printing may be used to distribute the fibrous reinforcing material along an interface effectively perpendicular to the macrostructures 12A, 12B and the bonding components 11A, 11B to inhibit fiber tear failure more effectively. In the disclosure, it is preferable that a fibrous reinforcing material provided perpendicular to the interface is laid on the interfaces of the macrostructures 12A, 12B and the bonding components 11A, 11B by using an additive addition technology such as 3D printing.

As shown in FIG. 2A, the first interlocking structure 10A also includes a first bonding trough 15A between the first macrostructures 12A. As shown in FIG. 2B, the second interlocking structure 10B also includes a second bonding trough 15B between the second macrostructures 12B.

As shown in FIGS. 2A and 2B, the length L_{B1} of the at least one second bonding trough 15B is greater than the length L_{A1} of the at least one first macrostructure 12A and/or the length L_{A2} of the at least one first bonding trough 15A is greater than the length L_{B2} of the at least one second macrostructure 12B in a direction L parallel to the distribution of the at least one first macrostructure 12A.

Referring to FIGS. 2A, 2B and 4, in a preferred embodiment, the length L_{B1} of the at least one second bonding trough 15B is equal to a sum of the length L_{A1} of the at least one first macrostructure 12A plus the gap length L_{C} or twice the gap length L_{C} between the first macrostructures 12A and the second macrostructures 12B in a direction L parallel to the distribution of the at least one of the first macrostructures 12A; the gap length L_{C} is equal to the adhesive thickness L_{T} in the direction L parallel to the distribution of at least one first macrostructure 12A, and the gap length L_{C} is greater than or equal to the adhesive thickness L_{T} in the direction T perpendicular to the bonding surface; and/or the length L_{A2} of the at least one first bonding trough 15A is equal to a sum of the length L_{B2} of the at least one second macrostructure 12B plus the gap length L_{C} or twice the gap length L_{C} between the first macrostructures 12A and the second macrostructures 12B in a direction L parallel to the distribution of the at least one second macrostructures 12B; the gap length L_{C} is equal to the adhesive thickness in the direction L parallel to the distribution of the at least one second macrostructure 12B and is greater than or equal to the adhesive thickness L_{T} in the direction T perpendicular to the bonding surface. Wherein the adhesive thickness L_{T} is an adhesive thickness between the first bonding troughs 15A and the second patterned microstructures 13B after the first interlocking structure 10A and the second interlocking structure 10B are aligned and bonded, or an adhesive thickness between the second bonding troughs 15B and the first patterned microstructures 13A.

As shown in FIGS. 3A and 3B, the first interlocking structure 10A further includes a first patterned microstructure 13A on the top plane of the first macrostructure 12A, and the second interlocking structure 10B further includes a second patterned microstructure 13B on the top plane of the second macrostructure 12B.

Some examples of suitable materials that may be used for the first patterned microstructure 13A and the second patterned microstructure 13B include, but are not limited to, polymer resins or polymer resin-based composite materials. Polymeric resin materials may include, but are not limited to, nylon (e.g., PA12, PA6, or PA66), polyimide (PI) resins (e.g., polycondensation-type aromatic polyimides, polybismaleimides, polyetherimide PEI, etc.), and polyaryletherketone (PAEK) resins (e.g., polyetheretherketone (PEEK), polyetherketone (PEK), polyetherketoneketone (PEKK), polyetheretherketoneketone (PEEKK), polyetherketoetherketoneketone (PEKEKK), and the like), or multilayer combinations of the above resins. The polymer resin-based composite materials comprise above polymer resin materials enhanced by high-performance fibers such as glass fibers, carbon fibers, carbon nanotubes, metal fibers, polyaramid fibers, basalt fibers and the like, or powder materials such as graphene, nano silicon oxide, nano silicon carbide and the like.

In some embodiments, the material used for producing the first patterned microstructures 13A and the second patterned microstructures 13B may be the same as the material used for producing the first macrostructures 12A and the second macrostructures 12B.

In other embodiments, the material used for producing the first patterned microstructures 13A and the second patterned microstructures 13B may be different from the material used for producing the first macrostructures 12A and the second macrostructures 12B, but the two materials have better chemical compatibility.

Preferably, in embodiments of the disclosure, the first patterned microstructures 13A and the second patterned microstructures 13B are preferably composed of the same material as first macrostructures 12A and second macrostructures 12B.

In some embodiments, the reinforcing material may be comprised of one of the reinforcing materials described above. In other embodiments, the reinforcing material may be comprised of a mixture of two or more of the afore-mentioned reinforcing materials, or a multilayer stack thereof.

The dimensions of the first patterned microstructures 13A and the second patterned microstructures 13B are generally less than 0.015 mm, typically between 0.001-0.015 mm. Compared to patterned microstructures with dimension of larger than 0.015 mm, these patterned microstructures can generally produce stronger chemical or physical interaction with the adhesive, provide additional surface roughness, and produce stronger mechanical interlock between the adhesive and the patterned microstructures under external forces.

At least one of the first patterned microstructures 13A and the second patterned microstructures 13B may be formed on the top planes of the first macrostructures 12A and the second macrostructures 12B using surface patterning techniques well known in the machining industry, such as nano-imprint and laser engraving processes; the first patterned microstructures 13A and the second patterned microstructures 13B may also be formed on the top planes of the first macrostructures 12A and the second macrostructures 12B using 3D print additive techniques such as powder bed forming, fused deposition molding, and ink jet printing.

In some embodiments, it is preferable to form the first patterned microstructures 13A and the second patterned microstructures 13B using an additive technique such as 3D printing. The advantage of using a material additive 3D printing technique is that not only can the dimensions of the patterned microstructures be precisely controlled, but also a three-dimensional structure that is difficult to shape by conventional machining techniques can be obtained.

In FIG. 4, a bonding composite structure is shown with the first and second exemplary interlocking structures shown in FIGS. 2A, 2B, 3A and 3B aligned. The process of aligning a bonding surface with another bonding surface comprises the following steps: inverting and overturning one of the exemplary interlocking structures of structured bonding component surface, such as the first interlocking structure 10A, and placing the overturned interlocking structure of structured bonding component surface on another interlocking structure of structured bonding component surface that is not inverted or overturned (such as the second interlocking structure 10B), so that the first macrostructure 12A of the first interlocking structure 10A is aligned with the second bonding trough 15B of the second interlocking structure 10B each other.

The surfaces of the bonded composite structures with aligning the surfaces of the first and second exemplary interlocking structures are coated with adhesive 300, respectively, and then bonded according to techniques well known in the bonding process. It is ensured that the first macrostructures 12A of the first interlocking structure extends completely through the second patterned microstructure 13B and the first end of the at least one first macrostructure 12A extends past the top plane of the first end of the at least one second macrostructure 12B; in addition, it is ensured that the second macrostructure 12B of the second interlocking structure extends completely through the first patterned microstructure 13A of the first interlocking structure and the first end of the at least one second macrostructure 12B extends past the top plane of the first end of the at least one first macrostructure 12A. Wherein after the surfaces of the bonded composite structures with aligning the surfaces of the first and second exemplary interlocking structures are coated with adhesive 300 and bonded, the thickness of the adhesive 300 remaining therebetween is represented by LT, and the distance between the first macrostructures 12A and the second macrostructures 12B is represented by LC, with the relevant dimensions enlarged herein for clarity.

### EXAMPLES

### Example 1

### Preparation of Single Lap Joint Strips Having Interlocking Structures with Macro-Stripped and Micro-Striped Surfaces

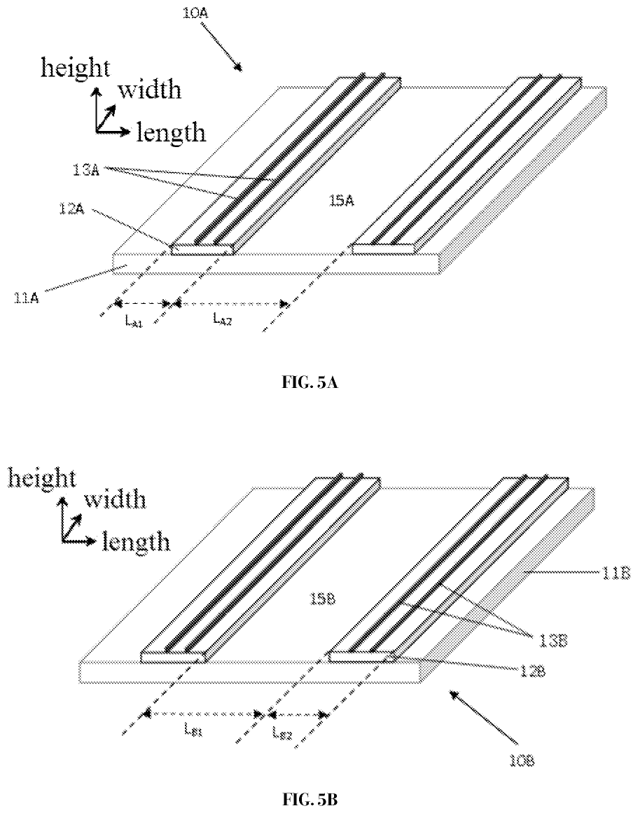

Referring to FIGS. 5A and 5B, a single lap joint strip is prepared having interlocking structures with macrostructures and patterned microstructures on the surface, wherein macrostructures and patterned microstructures are strip surfaces, respectively. The single lap joint strips comprise a first interlocking structure 10A and a second interlocking structure 10B, respectively. The first interlocking structure 10A and the second interlocking structure 10B also comprise a first bonding component 11A and a second bonding component 11B, respectively.

The first and second bonding components 11A and 11B each have a planar structured surface of 12.7 mm long (i.e. dimension in the length direction of the coordinates in FIGS. 5A and 5B, which is the same as that in the length direction referred to below in the present embodiment), 25.4 mm wide (i.e. dimension in the width direction of the coordinates in FIGS. 5A and 5B, which is the same as that in the width direction referred to below in the present embodiment), on which are uniformly provided with the first macrostructures 12A having a length L_{A1} of 1.2 mm, a width of 25.4 mm and a height of 0.2 mm and the second macrostructures 12B each having a length L_{B2} of 1.2 mm, a width of 25.4 mm and a height of 0.2 mm (i.e. dimension in the height direction of the coordinates in FIGS. 5A and 5B, the height direction referred to below in this embodiment being the same), respectively.

A plurality of first patterned microstructures 13A and a plurality of second patterned microstructures 13B with a length of 0.2 mm, a width of 25.4 mm and a height of 0.015 mm are also provided and uniformly spaced on the surfaces of the first macrostructures 12A and the second macrostructures 12B respectively; the distance between the first patterned microstructures 13A or between the second patterned microstructures 13B is 0.3 mm.

A first bonding trough 15A having a length L_{A2} of 1.3 mm, a width of 25.4 mm and a height of 0.215 mm, or a second bonding trough 15B having a length L_{B1} of 1.3 mm, a width of 25.4 mm and a height of 0.215 mm is also provided between the two first macrostructures 12A or the two second macrostructures 12B, respectively.

Wherein the length L_{A2} of the first bonding troughs 15A is greater than or equal to the length L_{B2} of the second macrostructures 12B, and the length L_{B1} of the second bonding troughs 15B is greater than or equal to the length L_{A1} of the first macrostructures 12A, preferably the length L_{A2} of the first bonding troughs 15A is equal to a sum of the length L_{B2} of the second macrostructures 12B plus the gap length L_{C} or twice the gap length L_{C} between the first macrostructures 12A and the second macrostructures 12B in a direction L parallel to the distribution of the first macrostructures 12A.

The gap length L_{C} is equal to the adhesive thickness in the direction L parallel to the distribution of the at least one first macrostructures 12A and is greater than or equal to the adhesive thickness L_{T} in the direction T perpendicular to the bonding surface.

Accordingly, the length of the second bonding troughs 15B is equal to a sum of the length L_{A1} of the first macrostructures 12A plus the gap length L_{C} or twice the gap length L_{C} between the first macrostructures 12A and the second macrostructures 12B in the direction L parallel to the distribution of the first macrostructures 12A. The gap length L_{C} is equal to the adhesive thickness in the direction L parallel to the distribution of the at least one of the second macrostructures 12B and is greater than or equal to the adhesive thickness L_{T} in the direction T perpendicular to the bonding surface.

The forming material is polyether ether ketone engineering plastic PEEK, and the single lap joint strip is formed at one time by adopting a fused extrusion forming 3D printing process. Forming conditions are as follows: a print temperature of 390 degrees centigrade, a platform temperature of 130 degrees centigrade, a layer thickness of 0.05 mm, and a print speed of 40 mm/s. Thereafter, a surface low temperature plasma treatment is performed according to ASTM D6105-04. The surface low-temperature plasma treatment conditions are as follows: the frequency is 21 kHz, the power is 280 W, the processing time is 180 s, the air pressure is 500 mbar, and the working distance is 10 mm.

During the bonding process, a Henkel LOCTITE EA 9380.05 AERO low temperature cure two-component adhesive 300 is applied to the surfaces of the first interlocking structure 10A and the second interlocking structure 10B. The top planes of the first macrostructures 12A are then aligned with the upper surfaces of the second bonding troughs 15B and the top planes of the second macrostructures 12B are aligned with the upper surfaces of the first bonding troughs 15A. Next, the bonding components 11A and 11B are pressed so that the adhesive 300 has a thickness of about 0.1 mm in the direction T perpendicular to the bonding component. Curing is carried out according to standard curing procedures and conditions for the adhesive LOCTITE EA 9380.05 AERO (i.e., at a constant temperature of 180° F./82° C. for 2 hours).

The adhesive bonding surface in this embodiment is a strip-like structure having stripped macrostructures and stripped microstructures disposed on the top plane thereof. Referring to FIG. 5A and 5B, shown is a single surface structure of a single lap joint strip of the first and second structured additive manufactured bonding components, respectively.

### Test of Properties Using Single Lap Joint (SLJ) Strips After Bonding

After curing, a single lap joint bonding strength test is conducted according to a standard ASTM D3163, and the test results are shown in Table 1 below:

TABLE 1

| | Smooth bonding | Only | Macrostructures + |
|---|---|---|---|
| | surface* | macrostructures** | Microstructures*** |
| Surface | 6.32 | 7.11 | 7.42 |
| roughness (μm) | | | |
| Bonding | 7.51 | 11.84 | 14.29 |
| strength (MPa) | | | |
| Failure mode | Failure of | Failure of | Tear of strip |
| | adhesion | adhesion | surface |

Notes:
*The surface is free of macrostructures 12A and 12B and microstructures 13A and 13B on the top plane of the macrostructures;
**The surface has only macrostructures 12A and 12B, and the top plane of macrostructures has no microstructures 13A and 13B;
***Not only macrostructures 12A and 12B are included on the surface, but the microstructures 13A and 13B are included on the top plane of macrostructures.

From the above test results, it can be seen that the bonding strength of single lap joint strip without macrostructures and microstructures provided on the surface thereof is the lowest, and its failure mode is adhesive failure; the bonding strength of the single lap joint strip with only macrostructures provided on the surface thereof is medium, and the failure mode of the single lap joint strip is adhesive failure; and the bonding strength of the single lap joint strip with the macrostructures and the microstructures provided on the surface thereof is the highest, and its failure mode of the single lap joint strip with the macrostructures and the microstructures provided on the surface thereof is the tearing of the surface of the strip. It can be seen that the bonding strength of a single lap joint strip provided with macrostructures and microstructures on surface thereof can be used in applications with extremely demanding strength, such as in the joints of components on an airframe.

### Example 2

Preparation of dual cantilever strips having interlocking structures of square macrostructures and cylindrical microstructure surfaces on the surface thereof

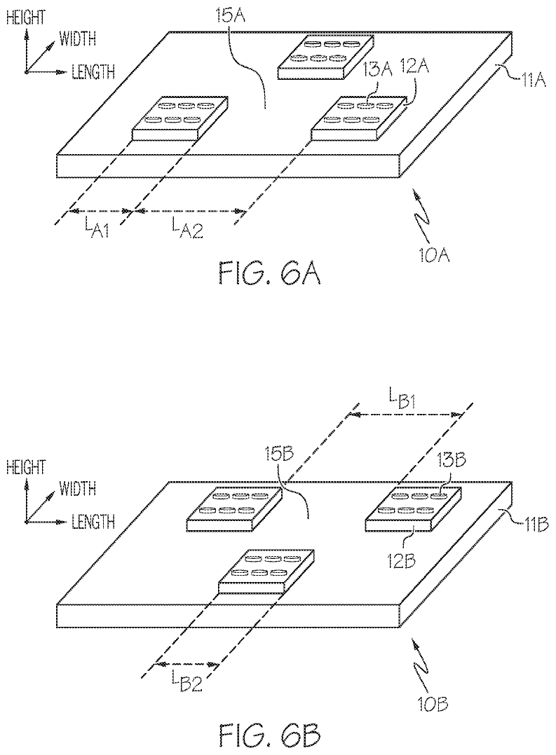

Referred to FIGS. 6A and 6B, dual cantilever strips having interlocking structures of square macrostructures and cylindrical microstructure surfaces on the surface thereof are prepared. The dual cantilever strips include a first interlocking structure 10A and a second interlocking structure 10B, respectively. The first interlocking structure 10A and the second interlocking structure 10B also comprise a first bonding component 11A and a second bonding component 11B, respectively.

The first bonding components 11A and the second bonding components 11B have planar surfaces with a length of 63 mm and a width of 22 mm, respectively, and the first macrostructures 12A and second macrostructures 12B with a length of 4.28 mm, a width of 4.28 mm and a height of 0.1 mm are uniformly provided on the top planes thereof, respectively; a plurality of first patterned microstructures 13A and a plurality of second patterned microstructures 13B with diameter of 0.8 mm and height of 0.01 mm are uniformly provided on the surfaces of the first macrostructures 12A and the second macrostructures 12B at intervals respectively; the distance between two the first patterned microstructures 13A or between two the second patterned microstructure 13B is 0.1 mm.

A first bonding trough 15A or a second bonding trough 15B having a length of 4.58 mm, a width of 4.58 mm, and a height of 0.11 mm is also provided between the two first and second macrostructures 12A and 12B, respectively.

Wherein the length L_{A2} of the first bonding troughs 15A is greater than or equal to the length L_{B2} of the second macrostructures 12B, and the length L_{B1} of the second bonding troughs 15B is greater than or equal to the length L_{A1} of the first macrostructures 12A; preferably, the length L_{A2} of the first bonding troughs 15A is equal to a sum of the length L_{B2} of the second macrostructures 12B plus the gap length L_{C} or twice the gap length L_{C} between the first macrostructures 12A and the second macrostructures 12B in a direction L parallel to the distribution of the first macrostructure 12A.

The gap length L_{C} is equal to the adhesive thickness in the direction L parallel to the distribution of the at least one first macrostructure 12A and is greater than or equal to the adhesive thickness L_{T} in the direction T perpendicular to the bonding surface.

Accordingly, the length L_{B1} of the second bonding troughs 15B is equal to a sum of the length L_{A1} of the first macrostructures 12A plus the gap length L_{C} or twice the gap length L_{C} between the first macrostructures 12A and the second macrostructures 12B in the direction L parallel to the distribution of the first macrostructures 12A. The gap length L_{C} is equal to the adhesive thickness in the direction L parallel to the distribution of the at least one second macrostructure 12B and is greater than or equal to the adhesive thickness L_{T} in the direction T perpendicular to the bonding surface.

The forming material is carbon fiber composite nylon 12 (i.e., comprising fiber reinforced structures 14A and/or 14B), and a selective laser sintering 3D printing process is adopted to carry out dual cantilever strips one-time forming. Forming conditions are as follows: a chamber temperature of 164 degrees centigrade, a platform temperature of 151 degrees centigrade, a layer thickness of 0.15 micrometers, a laser power of 20 W, laying powder in the T direction, i.e., a direction perpendicular to the surface, and then printing.

And after printing, surface low-temperature plasma treatment is carried out according to the standard ASTM D 6105-04, wherein the treatment conditions are as follows: the frequency is 21 kHz, the power is 280 W, the processing time is 180 s, the air pressure is 500 mbar, and the working distance is 10 mm.

In the bonding process, a 3M AF 163.2 structural bonding film is laid on the surface of the first interlocking structure 10A and the surface of the second interlocking structure 10B, and then the top plane of the first macrostructures 12A and the upper surface of the second bonding troughs 15B is aligned with each other and the top plane of the second macrostructures 12B is aligned with the upper surface of the first bonding trough 15A each other. They are pressed against each other and then thermostatically cured at a constant temperature of 250° F./121° C. for 60 minutes.

The bonding surface of this example is a square macrostructure having columnar microstructures thereon. Referring specifically to FIGS. 6A and 6B, a composite structure of a dual cantilever strip is shown, wherein A and B show a single surface structure of the dual cantilever strip of the first and second structured additive manufactured bonding components, respectively.

### Test of the Properties Using Dual Lap Joint (DCB) Strips After Bonding

After curing, the dual cantilever bonding strength test was performed according to the standard ASTM D5528-13, and the test results are shown in Table 2 below:

TABLE 2

| | Smooth bonding | Only | Macrostructures + |
|---|---|---|---|
| | surface* | macrostructures** | Microstructures*** |
| Surface roughness | 25.3 | 32.4 | 18.7 |
| (μm) | | | |
| Fracture toughness | 2051.2 | 2289.8 | 2600.2 |
| (J/m²) | | | |
| Failure mode | Failure of | Failure of | Tear of strip |
| | adhesion | adhesion | surface |

Notes:
*The surface is free of macrostructures 12A and 12B and microstructures 13A and 13B on the top plane of the macrostructures;
**The surface has only macrostructures 12A and 12B, and the top plane of macrostructures has no microstructures 13A and 13B;
***Not only macrostructures 12A and 12B are included on the surface, but the microstructures 13A and 13B are included on the top plane of macrostructures.

From the above test results, it can be seen that the bonding strength of dual cantilever strip without macrostructures and microstructures provided on the surface thereof is the lowest, and its failure mode is adhesive failure; the bonding strength of the dual cantilever strip with only macrostructures provided on the surface thereof is medium, and the failure mode of the dual cantilever strip is adhesive failure; the bonding strength of the dual cantilever strip with the macrostructures and the microstructures provided on the surface of the macrostructures is the highest, and its failure mode of the dual cantilever strip with the macrostructures and the microstructures provided on the surface of the macrostructures is the tearing of the surface of the strip. It can be seen that the bonding strength of a dual cantilever strip provided with macrostructures and microstructures on its surface can be used in applications with extremely demanding strength, such as in the joints of components on an airframe.

As can be seen from the above examples, the bonding effect and the bonding strength can be greatly improved by using the multi-level interlocking structure according to the disclosure.

Although the disclosure has been particularly shown and described with reference to preferred embodiments thereof, it will be understood by a person skilled in the art that the foregoing and other changes in form and details may be made therein without departing from the spirit and scope of the disclosure. Therefore, variations that conform to the inventive principles of disclosure are considered to be within the scope of the disclosure.

While the disclosure has been particularly shown and described with reference to preferred embodiments thereof, it will be understood by a person skilled in the art that various changes in form and details may be made therein. It is intended that the disclosure cover the modifications and variations of this disclosure provided they come within the spirit and scope of this disclosure.

Further, the disclosure comprise examples according to the following clauses:

Clause 1: A three-dimensional structured multi-level interlocking structure, comprising: a first interlocking structure (10A) and a second interlocking structure (10B), the first interlocking structure (10A) comprises a first bonding component (11A), at least one first bonding trough (15A) and at least one first macrostructure (12A) alternately positioned on the surface of the first bonding component (11A), the second interlocking structure (10B) comprises a second bonding component (11B), at least one second bonding trough (15B) and at least one second macrostructure (12B) alternately positioned on the surface of the second bonding component (11B), wherein the at least one first macrostructure (12A) is aligned with the at least one second bonding trough (15B), and the at least one second macrostructure (12B) is aligned with the at least one first bonding trough (15A), and wherein the at least one first macrostructure (12A) has a first end away from the first bonding component (11A) and the at least one second macrostructure (12B) has a first end away from the second bonding component (11B), the first ends of the at least one first macrostructure (12A) and the at least one second macrostructure (12B) comprise a top plane, wherein the first end of the at least one first macrostructure (12A) extends past the top plane of the first end of the at least one second macrostructure (12B), or wherein the first end of the at least one second macrostructure (12B) extends past the top plane of the first end of the at least one first macrostructure (12A).

Clause 2: The three-dimensional structured multi-level interlocking structure according to Clause 1, wherein at least one first patterned microstructure (13A) is further included on the top plane of the at least one first macrostructure (12A), and/or at least one second patterned microstructure (13B) is further included on the top plane of the at least one second macrostructure (12B); wherein the at least one first macrostructure (12A) extends completely through at least one second patterned microstructure (13B) and the first end of the at least one first macrostructure (12A) extends past the top plane of the first end of the at least one second macrostructure (12B), or the at least one second macrostructure (12B) extends completely through the at least one first patterned microstructure (13A) and the first end of the at least one second macrostructure (12B) extends past the top plane of the first end of the at least one first macrostructure (12A).

Clause 3: The three-dimensional structured multi-level interlocking structure according to Clause 1 or Clause 2, wherein a fibrous reinforcing material (14A,14B) is provided between the first bonding component (11A) and the at least one first macrostructure (12A) and between the second bonding component (11B) and the at least one second macrostructure (12B), and the fibrous reinforcing material (14A, 14B) extends through, preferably vertically through, the interface between the first bonding component (11A) and the at least one first macrostructure (12A) and the interface between the second bonding component (11B) and the at least one second macrostructure (12B).

Clause 4: The three-dimensional structured multi-level interlocking structure according to Clause 2, wherein the first interlocking structure (10A) comprises two or more first macrostructures (12A) and two or more first patterned microstructures (13A) positioned on the top planes of the first macrostructures (12A), and the second interlocking structure (10B) comprises two or more second macrostructures (12B) and two or more second patterned microstructures (13B) positioned on the top planes of the second macrostructures (12B).

Clause 5. The three-dimensional structured multi-level interlocking structure according to Clause 1 or Clause 2, wherein a length (L_{B1}) of the at least one second bonding trough (15B) is greater than a length (L_{A1}) of the at least one first macrostructure (12A) in a direction (L) parallel to distribution of the at least one first macrostructure (12A), and/or a length (L_{A2}) of the at least one first bonding trough (15A) is greater than a length (L_{B2}) of the at least one second macrostructure (12B); preferably, the length (LBO of the at least one second bonding trough (15B) is equal to a sum of the length (L_{A1}) of the at least one first macrostructure (12A) plus a gap length (L_{C}) or twice the gap length (L_{C}) between the first macrostructures (12A) and the second macrostructures (12B) in the direction (L) parallel to the distribution of the at least one first macrostructure (12A), and the gap length (L_{C}) is equal to an adhesive thickness in a direction (L) parallel to distribution of the at least one first macrostructure (12A) and greater than or equal to the adhesive thickness (L_{T}) in a direction (T) perpendicular to the bonding surface; and/or the length (L_{A2}) of the at least one first bonding trough (15A) is equal to a sum of the length (L_{B2}) of the at least one second macrostructure (12B) plus the gap length (L_{C}) or twice the gap length (L_{C}) between the first macrostructures (12A) and the second macrostructures (12B) in the direction (L) parallel to the distribution of the at least one second macrostructure (12B), and the gap length (L_{C}) is equal to the adhesive thickness in a direction (L) parallel to the distribution of the at least one second macrostructure (12B) and greater than or equal to the adhesive thickness (L_{T}) in a direction (T) perpendicular to the bonding surface.

Clause 6: The three-dimensional structured multi-level interlocking structure according to Clause 2, wherein heights of the at least one first macrostructure (12A) and of the at least one second macrostructure (12B) are between 0.02 mm and 0.2 mm, and the heights of the at least one first patterned microstructure (13A) and of the at least one second patterned microstructure (13B) are between 0.001 mm and 0.015 mm.

Clause 7: The three-dimensional structured multi-level interlocking structure according to Clause 1 or Clause 2, wherein the heights of the at least one of the at least one first macrostructure (12A) and of the at least one second macrostructure (12B) are half or more of the thickness (L_{T}) of the adhesive in the direction (T) perpendicular to the bonding surface.

Clause 8: The three-dimensional structured multi-level interlocking structure according to Clause 2, wherein the at least one first macrostructure (12A) and the at least one second macrostructure (12B), the at least one first patterned microstructure (13A) and the at least one second patterned microstructure (13B), and the first bonding component (11A) and the second bonding component (11B) are made of the same material or different materials selected from the group consisting of polymer resins and polymer resin-based composite materials.

Clause 9: A method for preparing a three-dimensional structured multi-level interlocking structure according to any one of Clause 1-8, comprising:
providing a first interlocking structure (10A),
providing a second interlocking structure (10B), and
bonding the first interlocking structure (10A) and the second interlocking structure(10B) by means of an adhesive such that at least one first macrostructure (12A) is aligned with the at least one second bonding troughs (15B) and the at least one second macrostructure (12B) is aligned with the at least one first bonding trough (15A), and wherein the at least one first macrostructure (12A) has a first end away from the first bonding component (11A) and the at least one second macrostructure (12B) has a first end away from the second bonding component (11B), the first ends of the at least one first macrostructure (12A) and the at least one second macrostructure (12B) comprise a top plane, wherein the first end of the at least one first macrostructure (12A) extends past the top plane of the first end of the at least one second macrostructure (12B), or wherein the first end of the at least one second macrostructure (12B) extends past the top plane of the first end of the at least one first macrostructure (12A), and
wherein the at least one first macrostructure (12A) and the at least one second macrostructure (12B) are formed by a powder bed forming, fused deposition molding, nano-imprinting or laser engraving process.

Clause 10: The method according to Clause 9, wherein the at least one first patterned microstructure (13A) is further included on the top plane of the at least one first macrostructure (12A), and/or the at least one second patterned microstructure (13B) is further included on the top plane of the at least one second macrostructure (12B); the at least one first macrostructure (12A) extends completely through the at least one second patterned microstructure (13B) and the first end of the at least one first macrostructure (12A) extends past the top plane of the first end of the at least one second macrostructure (12B), or the at least one second macrostructure (12B) extends completely through the at least one first patterned microstructure (13A) and the first end of the at least one second macrostructure (12B) extends past the top plane of the first end of the at least one first macrostructure (12A); and the at least one first patterned microstructure (13A) and the at least one second patterned microstructure (13B) are formed by powder bed forming, fused deposition molding, nano-imprinting, or laser engraving processes.

Clause 11: The method according to Clause 10, wherein before the first interlocking structure (10A) and the second interlocking structure (10B) are bonded by an adhesive, the at least one second patterned microstructure (13B) on the top plane of the at least one second macrostructure (12B) and/or the at least one first patterned microstructure (13A) on the top plane of the at least one first macrostructure (12A) and the at least one first bonding trough (15A) and/or the at least one second bonding trough (15B) are subjected to a surface treatment at a temperature of 0-150 degrees centigrade, the surface treatment is selected from plasma treatment, mechanical abrasion or chemical etching, so that roughness of the bonding surface is between 1.5 and 15 micrometers, and the contact angle with water is below 18 degrees.

Clause 12: The method according to Clause 11, wherein the gas used in the plasma surface treatment is selected from at least one of oxygen, air, argon and helium.

Clause 13. The method according to Clause 11, wherein the first interlocking structure (10A) and the second interlocking structure (10B) are combined by an adhesive within 8 hours after surface treatment by plasma.

What is claimed is:

1. A three-dimensional structured multi-level interlocking structure, comprising: a first interlocking structure and a second interlocking structure, the first interlocking structure comprises a first bonding component, at least one first bonding trough and at least one first macrostructure alternately positioned on a bonding surface of the first bonding component, the second interlocking structure comprises a second bonding component, at least one second bonding trough and at least one second macrostructure alternately positioned on a bonding surface of the second bonding component, wherein the at least one first macrostructure is aligned with the at least one second bonding trough, and the at least one second macrostructure is aligned with the at least one first bonding trough, and wherein the at least one first macrostructure has a first end away from the first bonding component and the at least one second macrostructure has a first end away from the second bonding component, the first ends of the at least one first macrostructure and the at least one second macrostructure comprise a top plane, wherein the first end of the at least one first macrostructure extends past the top plane of the first end of the at least one second macrostructure, or wherein the first end of the at least one second macrostructure extends past the top plane of the first end of the at least one first macrostructure.

2. The three-dimensional structured multi-level interlocking structure according to claim 1, wherein a fibrous reinforcing material is provided between the first bonding component and the at least one first macrostructure and between the second bonding component and the at least one second macrostructure, and the fibrous reinforcing material extends through, preferably vertically through, an interface between the first bonding component and the at least one first macrostructure and an interface between the second bonding component and the at least one second macrostructure.

3. The three-dimensional structured multi-level interlocking structure according to claim 1, wherein a length of the at least one second bonding trough is greater than a length of the at least one first macrostructure in a direction parallel to distribution of the at least one first macrostructure, and/or a length of the at least one first bonding trough is greater than a length of the at least one second macrostructure; preferably, the length of the at least one second bonding trough is equal to a sum of the length of the at least one first macrostructure plus a gap length or twice the gap length between the first macrostructures and the second macrostructures in the direction parallel to the distribution of the at least one first macrostructure, and the gap length is equal to an adhesive thickness in a direction parallel to distribution of the at least one first macrostructure and greater than or equal to the adhesive thickness in a direction perpendicular to the bonding surface; and/or the length of the at least one first bonding trough is equal to a sum of the length of the at least one second macrostructure plus the gap length or twice the gap length between the first macrostructures and the second macrostructures in the direction parallel to the distribution of the at least one second macrostructure, and the gap length is equal to the adhesive thickness in a direction parallel to the distribution of the at least one second macrostructure and greater than or equal to the adhesive thickness in a direction perpendicular to the bonding surface.

4. The three-dimensional structured multi-level interlocking structure according to claim 1, wherein a height of the at least one of the at least one first macrostructure and a height of the at least one second macrostructure are half or more of an adhesive thickness in the direction perpendicular to the bonding surface.

5. A method for preparing a three-dimensional structured multi-level interlocking structure according to claim 1, comprising:
providing a first interlocking structure,
providing a second interlocking structure, and
bonding the first interlocking structure and the second interlocking structure with an adhesive such that at least one first macrostructure is aligned with the at least one second bonding troughs and the at least one second macrostructure is aligned with the at least one first bonding trough, and wherein the at least one first macrostructure has a first end away from the first bonding component and the at least one second macrostructure has a first end away from the second bonding component, the first ends of the at least one first macrostructure and the at least one second macrostructure comprise a top plane, wherein the first end of the at least one first macrostructure extends past the top plane of the first end of the at least one second macrostructure, or wherein the first end of the at least one second macrostructure extends past the top plane of the first end of the at least one first macrostructure, and
wherein the at least one first macrostructure and the at least one second macrostructure are formed by a powder bed forming, fused deposition molding, nano-imprinting or laser engraving process.

6. The method according to claim 5, wherein at least one first patterned microstructure is further included on the top plane of the at least one first macrostructure, and/or at least one second patterned microstructure is further included on the top plane of the at least one second macrostructure;
the at least one first macrostructure extends completely through the at least one second patterned microstructure and the first end of the at least one first macrostructure extends past the top plane of the first end of the at least one second macrostructure, or the at least one second macrostructure extends completely through the at least one first patterned microstructure and the first end of the at least one second macrostructure extends past the top plane of the first end of the at least one first macrostructure; and
the at least one first patterned microstructure and the at least one second patterned microstructure are formed by powder bed forming, fused deposition molding, nano-imprinting, or laser engraving processes.

7. The method according to claim 6, wherein before the first interlocking structure and the second interlocking structure are bonded by an adhesive, the at least one second patterned microstructure on the top plane of the at least one second macrostructure and/or the at least one first patterned microstructure on the top plane of the at least one first macrostructure and the at least one first bonding trough and/or the at least one second bonding trough are subjected to a surface treatment at a temperature of 0-150 degrees centigrade, the surface treatment is selected from plasma surface treatment, mechanical abrasion or chemical etching, so that roughness of the bonding surface is between 1.5 and 15 micrometers, and a contact angle with water is below 18 degrees.

8. The method according to claim 7, wherein a gas used in the plasma surface treatment is selected from at least one of oxygen, air, argon and helium.

9. The method according to claim 7, wherein the first interlocking structure and the second interlocking structure are combined by an adhesive within 8 hours after surface treatment by plasma.

10. A three-dimensional structured multi-level interlocking structure, comprising: a first interlocking structure and a second interlocking structure, the first interlocking structure comprises a first bonding component, at least one first bonding trough and at least one first macrostructure alternately positioned on the bonding surface of the first bonding component, the second interlocking structure comprises a second bonding component, at least one second bonding trough and at least one second macrostructure alternately positioned on the bonding surface of the second bonding component, wherein the at least one first macrostructure is aligned with the at least one second bonding trough, and the at least one second macrostructure is aligned with the at least one first bonding trough, and wherein the at least one first macrostructure has a first end away from the first bonding component and the at least one second macrostructure has a first end away from the second bonding component, the first ends of the at least one first macrostructure and the at least one second macrostructure comprise a top plane, wherein the first end of the at least one first macrostructure extends past the top plane of the first end of the at least one second macrostructure, or wherein the first end of the at least one second macrostructure extends past the top plane of the first end of the at least one first macrostructure, wherein at least one first patterned microstructure is further included on the top plane of the at least one first macrostructure, and/or at least one second patterned microstructure is further included on the top plane of the at least one second macrostructure, and
wherein the at least one first macrostructure extends completely through at least one second patterned microstructure and the first end of the at least one first macrostructure extends past the top plane of the first end of the at least one second macrostructure, or the at least one second macrostructure extends completely through the at least one first patterned microstructure and the first end of the at least one second macrostructure extends past the top plane of the first end of the at least one first macrostructure.

11. The three-dimensional structured multi-level interlocking structure according to claim 10, wherein a fibrous reinforcing material is provided between the first bonding component and the at least one first macrostructure and between the second bonding component and the at least one second macrostructure, and the fibrous reinforcing material extends through, preferably vertically through, the interface between the first bonding component and the at least one first macrostructure and the interface between the second bonding component and the at least one second macrostructure.

12. The three-dimensional structured multi-level interlocking structure according to claim 10, wherein the first interlocking structure comprises two or more first macrostructures and two or more first patterned microstructures positioned on the top planes of the first macrostructures, and the second interlocking structure comprises two or more second macrostructures and two or more second patterned microstructures positioned on the top planes of the second macrostructures.

13. The three-dimensional structured multi-level interlocking structure according to claim 10, wherein a length of the at least one second bonding trough is greater than a length of the at least one first macrostructure in a direction parallel to distribution of the at least one first macrostructure, and/or a length of the at least one first bonding trough is greater than a length of the at least one second macrostructure; preferably, the length of the at least one second bonding trough is equal to a sum of the length of the at least one first macrostructure plus a gap length or twice the gap length between the first macrostructures and the second macrostructures in the direction parallel to the distribution of the at least one first macrostructure, and the gap length is equal to an adhesive thickness in a direction parallel to distribution of the at least one first macrostructure and greater than or equal to the adhesive thickness in a direction perpendicular to the bonding surface; and/or the length of the at least one first bonding trough is equal to a sum of the length of the at least one second macrostructure plus the gap length or twice the gap length between the first macrostructures and the second macrostructures in the direction parallel to the distribution of the at least one second macrostructure, and the gap length is equal to the adhesive thickness in a direction parallel to the distribution of the at least one second macrostructure and greater than or equal to the adhesive thickness in a direction perpendicular to the bonding surface.

14. The three-dimensional structured multi-level interlocking structure according to claim 10, wherein heights of the at least one first macrostructure and of the at least one second macrostructure are between 0.02 mm and 0.2 mm, and the heights of the at least one first patterned microstructure and of the at least one second patterned microstructure are between 0.001 mm and 0.015 mm.

15. The three-dimensional structured multi-level interlocking structure according to claim 10, wherein a height of the at least one of the at least one first macrostructure and a height of the at least one second macrostructure are half or more of an adhesive thickness in the direction perpendicular to the bonding surface.

16. The three-dimensional structured multi-level interlocking structure according to claim 10, wherein the at least one first macrostructure and the at least one second macrostructure, the at least one first patterned microstructure and the at least one second patterned microstructure, and the first bonding component and the second bonding component are made of the same material or different materials selected from the group consisting of polymer resins and polymer resin-based composite materials.

17. A method for preparing a three-dimensional structured multi-level interlocking structure according to claim 10, comprising:
providing a first interlocking structure,
providing a second interlocking structure, and
bonding the first interlocking structure and the second interlocking structure with an adhesive such that at least one first macrostructure is aligned with the at least one second bonding troughs and the at least one second macrostructure is aligned with the at least one first bonding trough, and wherein the at least one first macrostructure has a first end away from the first bonding component and the at least one second macrostructure has a first end away from the second bonding component, the first ends of the at least one first macrostructure and the at least one second macrostructure comprise a top plane, wherein the first end of the at least one first macrostructure extends past the top plane of the first end of the at least one second macrostructure, or wherein the first end of the at least one second macrostructure extends past the top plane of the first end of the at least one first macrostructure, and
wherein the at least one first macrostructure and the at least one second macrostructure are formed by a powder bed forming, fused deposition molding, nano-imprinting or laser engraving process.

18. The method according to claim 17, wherein the at least one first patterned microstructure is further included on the top plane of the at least one first macrostructure, and/or the at least one second patterned microstructure is further included on the top plane of the at least one second macrostructure;
the at least one first macrostructure extends completely through the at least one second patterned microstructure and the first end of the at least one first macrostructure extends past the top plane of the first end of the at least one second macrostructure, or the at least one second macrostructure extends completely through the at least one first patterned microstructure and the first end of the at least one second macrostructure extends past the top plane of the first end of the at least one first macrostructure; and
the at least one first patterned microstructure and the at least one second patterned microstructure are formed by powder bed forming, fused deposition molding, nano-imprinting, or laser engraving processes.

19. The method according to claim 18, wherein before the first interlocking structure and the second interlocking structure are bonded by an adhesive, the at least one second patterned microstructure on the top plane of the at least one second macrostructure and/or the at least one first patterned microstructure on the top plane of the at least one first macrostructure and the at least one first bonding trough and/or the at least one second bonding trough are subjected to a surface treatment at a temperature of 0-150 degrees centigrade, the surface treatment is selected from plasma surface treatment, mechanical abrasion or chemical etching, so that roughness of the bonding surface is between 1.5 and 15 micrometers, and a contact angle with water is below 18 degrees.

20. The method according to claim 19, wherein a gas used in the plasma surface treatment is selected from at least one of oxygen, air, argon and helium, and wherein the first interlocking structure and the second interlocking structure are combined by an adhesive within 8 hours after surface treatment by plasma.
